(19) United States
(12) Patent Application Publication
(10) Pub. No.: US 2008/0244405 A1
(43) Pub. Date: Oct. 2, 2008

(54) GUI DISPLAY SYSTEM RECORDING APPARATUS, AND GUI DISPLAY METHOD

(75) Inventor: Yoshio Kimura, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 12/024,523

(22) Filed: Feb. 1, 2008

(30) Foreign Application Priority Data
Mar. 30, 2007 (JP) 2007-090367

(51) Int. Cl. G06F 3/048

(52) U.S. Cl. 715/716

(57) ABSTRACT

According to one embodiment, a recording apparatus transmits a GUI screen to an image display apparatus via a LAN. A CPU of the screen display apparatus creates a selection border. The CPU and a graphics processor blend the created selection border with the GUI screen. A video processor/output unit displays the GUI screen on a display panel. The CPU and the graphics processor newly create a selection border according to a user's operation. The CPU and the graphics processor blend the created selection border with the displayed GUI screen to generate the GUI screen after updating. The video processor/output unit displays the generated GUI screen after updating on the display panel.

### CROSS-REFERENCE TO RELATED APPLICATIONS

This application is based upon and claims the benefit of priority from Japanese Patent Application No. 2007-90367, filed Mar. 30, 2007, the entire contents of which are incorporated herein by reference.

### BACKGROUND

1. Field

One embodiment of the invention relates to a GUI display system, a recording apparatus, and a GUI display method, and particularly relates to a GUI display system, a recording apparatus, and a GUI display method to display a GUI (Graphical User Interface) screen of the recording apparatus in an image display apparatus connected via a communication line.

2. Description of the Related Art

A GUI environment capable of using graphics a lot for display of information for a user and performing the majority of basic operations by specifying a cursor or an icon by a remote controller or the like in a television, a DVD recorder, and so on is proposed. For example, in Japanese Patent Application Publication (KOKAI) No. 2006-331162, a menu display apparatus is disclosed. This menu display apparatus receives menu operation information and operation response information on a user's desired response speed. Further, the menu display apparatus displays a menu screen based on the menu operation information and the operation response information. This enables the menu display apparatus to operate a menu at the user's desired response speed.

Moreover, in recent years, a television and a DVD recorder which are installed in separate rooms are connected via a communication line such as a LAN (Local Area Network). By operating a GUI screen of the DVD recorder displayed on a screen of the television in the room where the television is installed, the user operates the DVD recorder installed in the other room while staying in the room where the television is installed.

However, in the above art, if the user tries to operate the GUI screen of the DVD recorder from the television side in the environment where the television and the DVD recorder are connected via the LAN or the like, updating of the GUI screen is delayed due to the problem of the communication volume of the communication line, and the user's desired response speed is not obtained in some cases.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary side view showing the configuration of a GUI screen display system according to a first embodiment;

FIG. 2 is an exemplary schematic block diagram showing the configuration of an image display apparatus according to the first embodiment;

FIG. 3 is an exemplary schematic block diagram showing the configuration of a recording apparatus according to the first embodiment;

FIG. 4 is an exemplary sequence diagram showing the operation of the GUI display system according to the first embodiment;

FIG. 5 is an exemplary diagram showing a GUI screen of the recording apparatus according to the first embodiment;

FIG. 6 is an exemplary diagram showing a GUI map according to the first embodiment;

FIG. 7 is an exemplary diagram showing a GUI screen of the image display apparatus according to the first embodiment;

FIG. 8 is an exemplary diagram showing a GUI image after updating of an updated area according to a second embodiment;

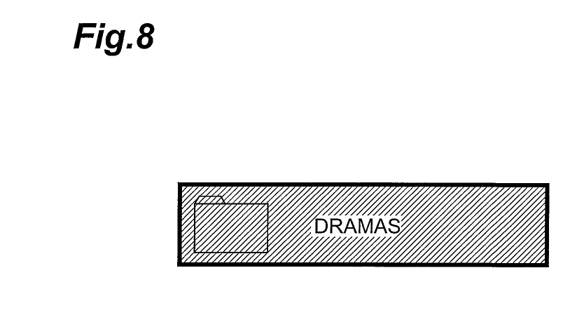

FIG. 9 is an exemplary diagram showing a GUI screen with the GUI image after updating displayed in the updated area on the image display apparatus side according to the second embodiment; and

FIG. 10 is an exemplary diagram showing a GUI screen with representations of icons corresponding to those of a remote controller of an image display apparatus in the image display apparatus according to a third embodiment.

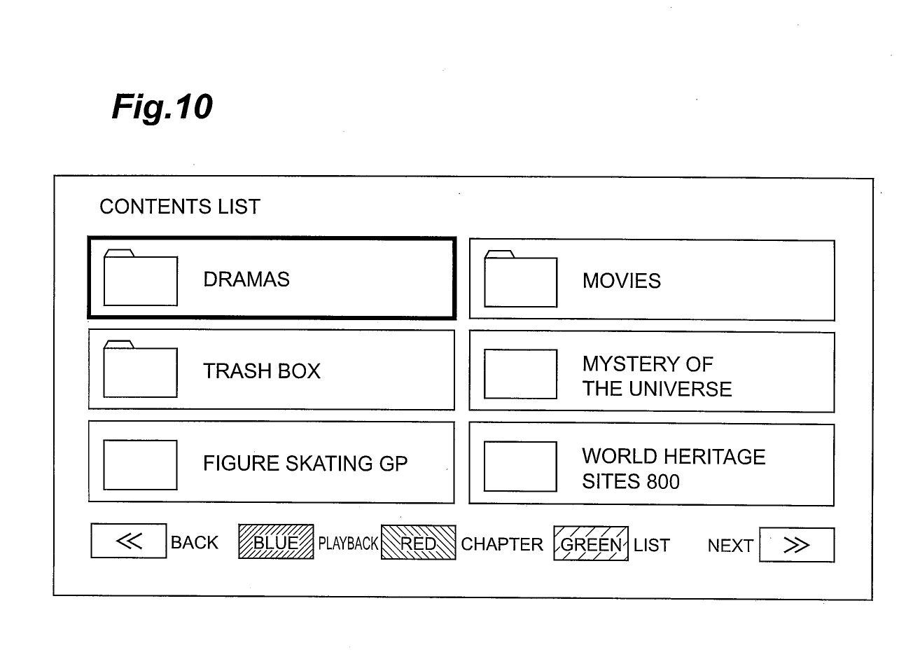

### DETAILED DESCRIPTION

Various embodiments according to the invention will be described hereinafter with reference to the accompanying drawings. In general, according to one embodiment of the invention, there is provided a GUI display system which displays a GUI of a recording apparatus in a display apparatus, wherein the display apparatus includes: a display device which displays a GUI related to data transmitted from the recording apparatus; and a blending device which blends an updated image of an area updated and displayed in the GUI with the GUI being displayed by the display device, and the display device displays the GUI with which the updated image is blended by the blending device.

There is provided a recording apparatus which allows a GUI of the recording apparatus to be displayed in a display apparatus, including an updated area data generating device which generates coordinate data of an area updated and displayed in the GUI, and transmitting the coordinate data generated by the updated area data generating device with data related to the GUI to the display apparatus.

There is provided a GUI display method of displaying a GUI of a recording apparatus in a display apparatus, including the steps of: a display device of the display apparatus displaying a GUI related to data transmitted from the recording apparatus; and a blending device of the display apparatus blending an updated image of an area updated and displayed in the GUI with the GUI being displayed by the display device, wherein the display device of the display apparatus displays the GUI with which the updated image is blended by the blending device.

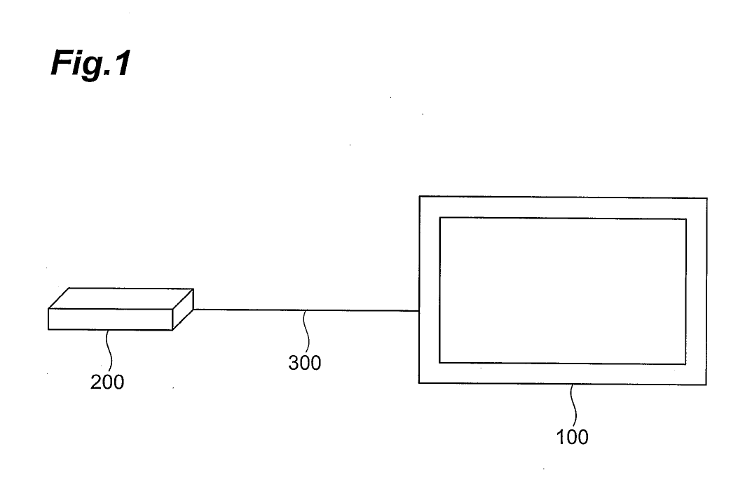

First, a GUI screen display system according to a first embodiment of the present invention will be described with reference to FIG. 1. As shown in FIG. 1, an image display apparatus 100 and a recording apparatus 200 are connected by a LAN (communication line) 300. The LAN 300 may be wired or wireless. Further, the image display apparatus 100 and the recording apparatus 200 may be connected by a MAN (Metropolitan Area Network) or a WAN (Wide Area Network) other than the LAN. Alternatively, the image display apparatus 100 and the recording apparatus 200 may be connected by a single-line cable, fiber optics, or the like other than the network connection.

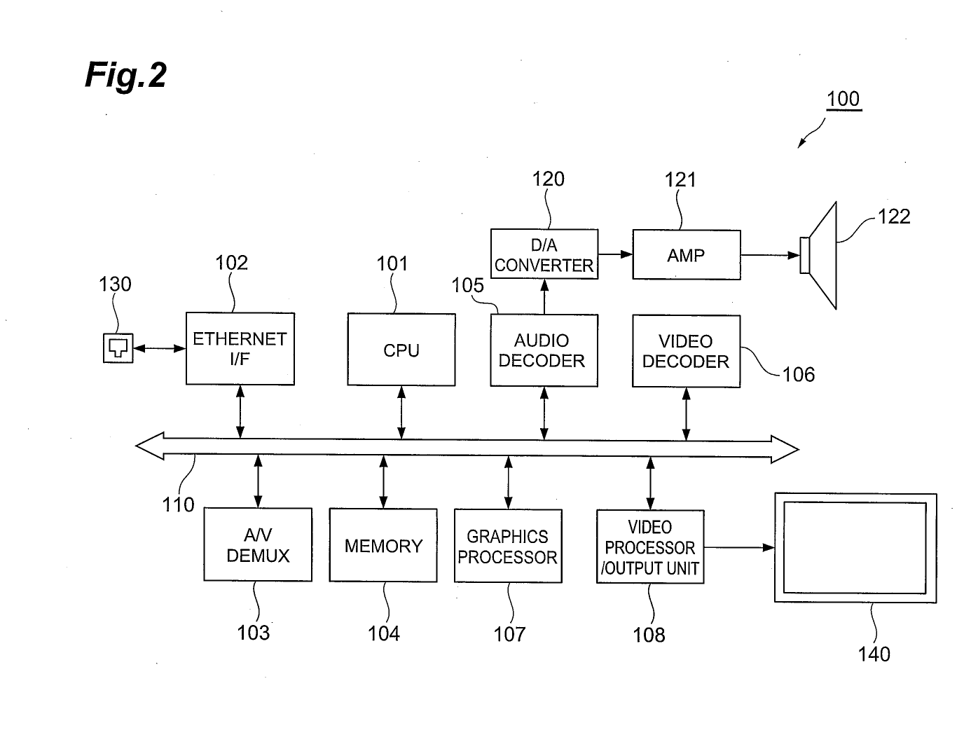

FIG. 2 is a schematic block diagram of the image display apparatus 100 according to the first embodiment. As shown in FIG. 2, the image display apparatus 100 includes a CPU (Central Processing Unit) 101, an Ethernet I/F 102, an A/V demultiplexer (Demux) 103, a memory 104, an audio decoder 105, a video decoder 106, a graphics processor 107, a video processor/output unit 108, a bus 110, a D/A converter 120, an amplifier (Amp) 121, a speaker 122, and a terminal 130.

The image display apparatus 100 is connected to the LAN by the terminal 130. An A/V stream inputted from the terminal 130 is demultiplexed into video data and audio data by the A/V demultiplexer 103 via the Ethernet I/F 102. The video data is decoded by the video decoder 106. The decoded video data is outputted as a video signal from the video processor/output unit 108 and displayed on a display panel 140. The display panel 140 functions as a display device.

The audio data is decoded by the audio decoder 105 and outputted from the speaker 122 through the D/A converter 120 and the amplifier 121.

The CPU 101 and the graphics processor 107 generate a GUI display screen (updated image) of an area updated and displayed in a GUI screen. The GUI display screen of the area updated and displayed in the GUI screen is stored in the memory 104. The GUI display screen of the area updated and displayed in the GUI screen generated by the CPU 101 and the graphics processor 107 is superimposed on the video signal by the video processor/output unit 108 and displayed on the display panel 140. The CPU 101, the graphics processor 107, and the video processor/output unit 108 function as an updated image generating device and a blending device.

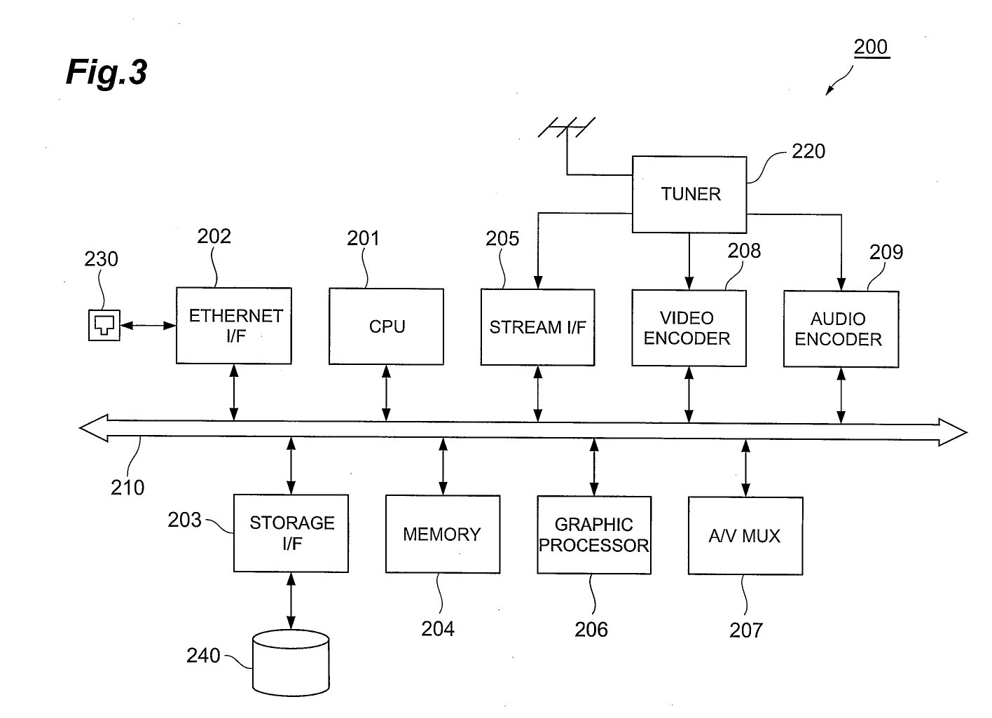

FIG. 3 is a schematic block diagram of the recording apparatus 200 according to the first embodiment. As shown in FIG. 3, the recording apparatus 200 includes a CPU 201, an Ethernet I/F 202, a storage I/F 203, a memory 204, a stream I/F 205, a graphics processor 206, an A/V multiplexer (MUX) 207, a video encoder 208, an audio encoder 209, a bus 210, a tuner 220, a terminal 230, and a storage 240.

A received analog audio signal is encoded by the audio encoder 209. Encoded video signal and audio signal are multiplexed into an A/V stream by the A/V multiplexer 207. On the other hand, a digital video signal received by the tuner 220 is inputted, for example, as an MPEG2TS (transport Stream) format A/V stream from the stream I/F 205. The A/V stream is recorded in the storage 240 via the storage I/F 203.

The A/V stream recorded in the storage 240 is read by the CPU 201. The A/V stream is outputted to the LAN 300 connected to the terminal 230 via the Ethernet I/F 202. A GUI display screen generated by the CPU 201 and the graphics processor 206 is held in the memory 204. Image data of the GUI display screen held in the memory 204 is read by the CPU 201. The image data of the GUI display screen is outputted to the LAN 300 connected to the terminal 230 via the Ethernet I/F 202. The CPU 201 and the graphics processor 206 function as an updated area data generating device.

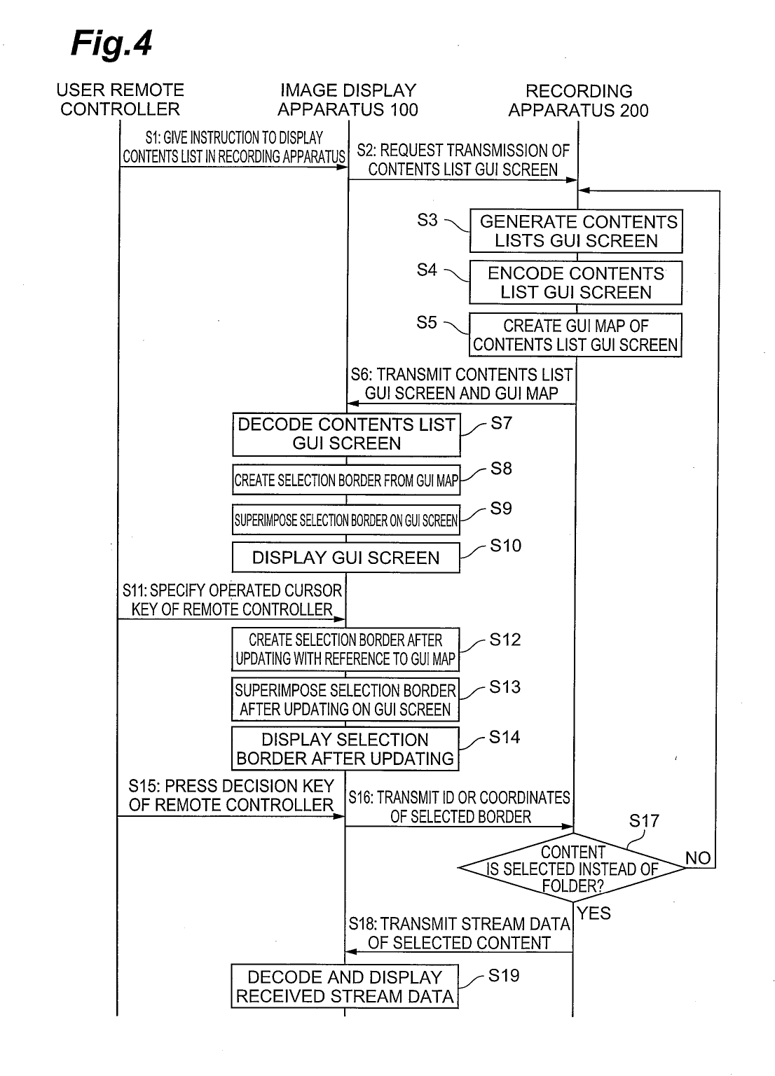

Next, with reference to FIG. 4, the operation of the GUI screen display system of this embodiment will be described using a case where a contents list GUI of contents recorded in the memory 240 of the recording apparatus 200 is displayed on the image display apparatus 100 side as an example. Incidentally, hereinafter, GUI updating means a display or a movement of a selection border (cursor or icon).

A remote controller of the display apparatus used by a user instructs the display apparatus 100 to display the contents list saved in the recording apparatus 200 connected to the LAN 300 (S1). The display apparatus 100 requests the recording apparatus 200 to transmit a GUI screen of the contents list (S2).

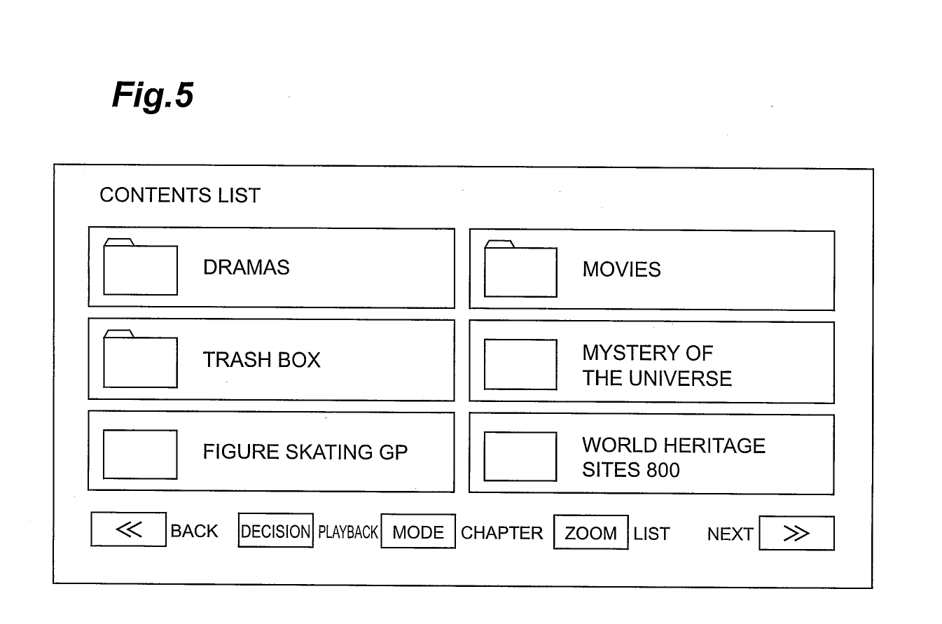

When the recording apparatus 200 receives the contents list GUI screen transmission request, the CPU 201 and the graphics processor 206 of the recording apparatus 200 generate a contents list GUI screen shown in FIG. 5 and hold it in the memory 204 (S3). The CPU 201, the video encoder 208, or a separately provided encoder not shown encodes image data of the generated GUI screen in a JPEG format or the like (S4).

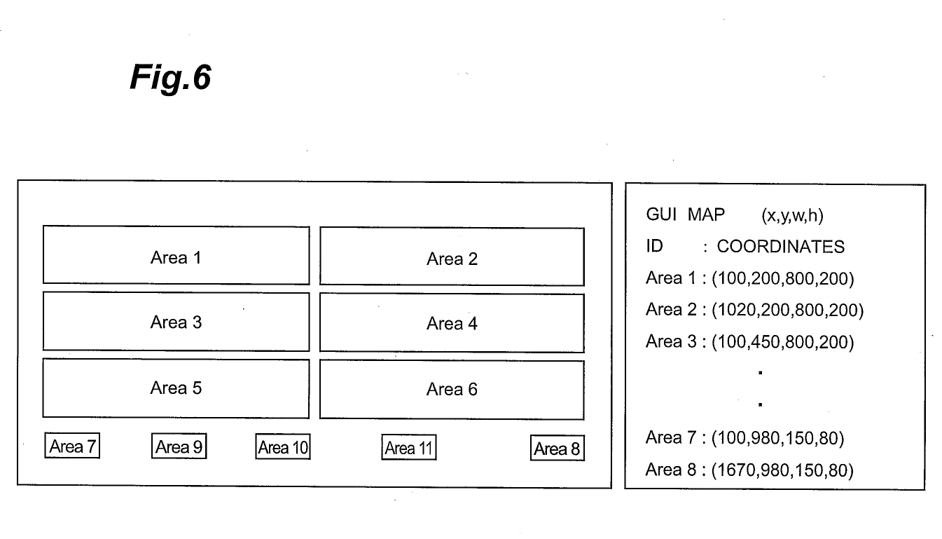

Further, the CPU 201 and the graphics processor 206 of the recording apparatus 200 create a GUI map such as shown in FIG. 6 which is data describing coordinates of areas requiring display updating by the GUI operation of the user in the generated GUI screen and their IDs (S5). The recording apparatus 200 transmits the encoded GUI screen and the GUI map to the display apparatus 100 from the Ethernet I/F 202 via the LAN 300 connected to the terminal 230 (S6).

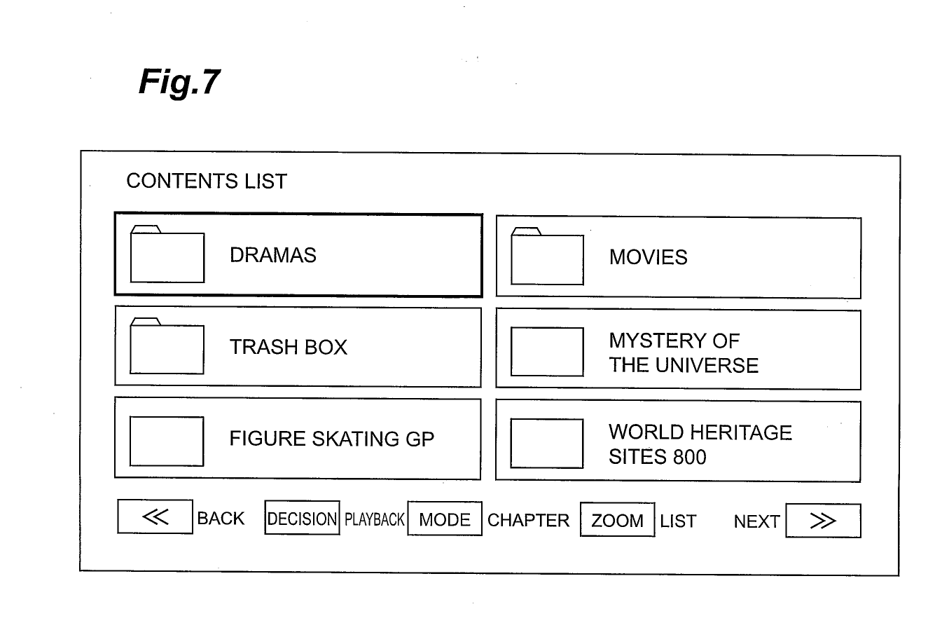

The CPU 101, the video decoder 106, or a separately provided video decoder not shown decodes an image signal of the GUI screen received via the terminal 130 and the Ethernet I/F 102 (S7). The CPU 101 and the graphics processor 107 create a selection border with reference to the GUI map (S8). The CPU 101 and the graphics processor 107 blend the created selection border with the GUI screen and store it in the memory 104 (S9). As shown in FIG. 7, the video processor/output unit 108 reads the generated GUI screen from the memory 104 and displays it on the display panel 140 (S10).

The user operates a cursor key of the remote controller of the image display apparatus 100 to select a desired content or folder from the displayed GUI screen. The remote controller of the image display apparatus 100 specifies the cursor key operated by the user for the image display apparatus 100 (S11). The CPU 101 and the graphics processor 107 of the image display apparatus 100 newly create a selection border (updated image) with reference to the GUI map according to the specification of the remote controller (S12). The CPU 101 and the graphics processor 107 of the image display apparatus 100 blend the created new selection border with the GUI screen being displayed on the display panel 140 to generate the GUI screen after updating (S13). The video processor/output unit 108 displays the generated GUI screen after updating on the display panel 140 (S14). In this case, the selection border appears to have moved, as seen from the viewpoint of the user.

The user presses a decision key of the remote controller of the image display apparatus 100 when moving the selection border to a desired position. The remote controller of the image display apparatus 100 instructs the image display apparatus 100 that the decision key is pressed (S15).

The image display apparatus 100 transmits an ID or coordinates of the area of the selection border selected when the decision key is pressed to the recording apparatus 200 (S16). The recording apparatus 200 performs processing according to the position at which the decision key is pressed. When the folder is selected, the recording apparatus 200 generates a GUI screen of a contents list in this folder again and performs the above processing (S17, S3). When the content is selected, the recording apparatus 200 reads stream data of the content from the storage 240 and transmits it to the image display apparatus 100 (S17, S18). The image display apparatus 100 decodes and displays the received content stream data (S19).

According to this embodiment, the CPU 101 and the graphics processor 107 of the image display apparatus 100 generate the selection border of the GUI screen every time the GUI screen updated and blend it with the GUI screen displayed until then to generate the GUI screen after updating. Therefore, it is unnecessary to acquire an updated portion of the GUI screen via the LAN 300 for each GUI operation by the user, so that a more responsive GUI screen display can be performed.

In particular, according to this embodiment, the recording apparatus 200 creates the GUI map, and the CPU 101 and the graphics processor 107 of the image display apparatus 100 generate the selection border of the GUI screen with reference to the GUI map and blend it with the GUI screen displayed on the display panel 140 until then to generate the GUI screen after updating. The GUI map has less data volume compared to image data of the entire GUI screen and hence does not cause a reduction in the speed of communication by the LAN 300. This enables the more responsive GUI screen display.

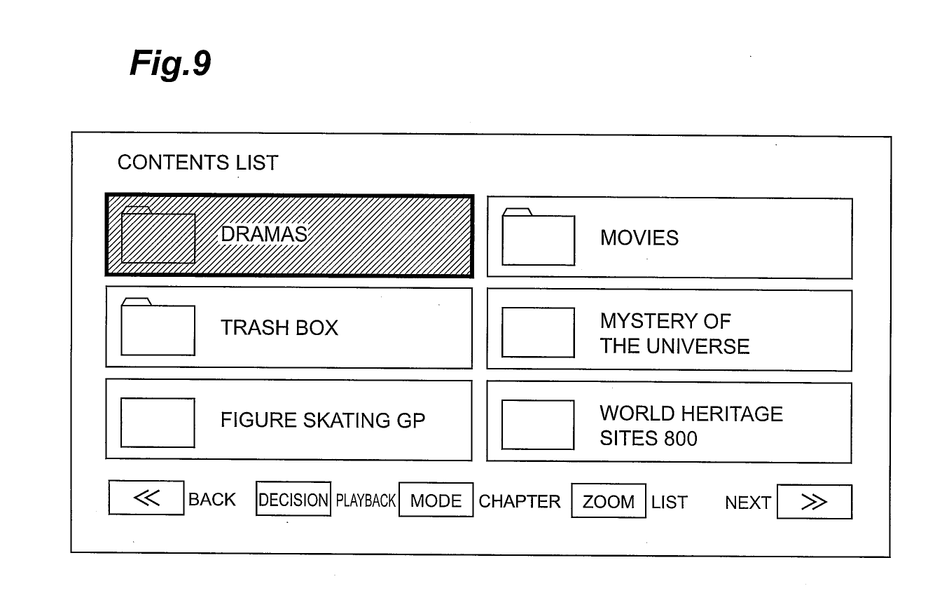

A second embodiment of the present invention will be described below. In this embodiment, a GUI image after updating of an area requiring display updating by a GUI operation such as shown in FIG. 7 is generated by the CPU 201 and the graphics processor 206 of the recording apparatus 200 in S5 of FIG. 4. In this embodiment, the CPU 201 and the graphics processor 206 of the recording apparatus 200 function as the updated image generating device. In this embodiment, in S6 of FIG. 4, the recording apparatus 200 transmits the GUI image after updating of the area requiring display updating together with the GUI screen in association with the GUI map to the image display apparatus 100. In this embodiment, without performing S8 of FIG. 9, in S9 and S11, the GUI screen after updating is generated by blending the GUI image after updating received from the recording apparatus 200 with the GUI screen displayed on the display panel 140 until then. As a result, the image display apparatus 100 displays the GUI screen such as shown in FIG. 9.

This embodiment has the advantage that since the CPU 201 and the graphics processor 206 of the recording apparatus 200 generate the GUI image after updating of the area requiring display updating by the GUI operation, the display mode of the GUI screen becomes close to that of the recording apparatus 200.

A third embodiment of the present invention will be described below. In this embodiment, the CPU 101 and the graphic processor 107 of the image display apparatus 100 convert the display mode of the GUI screen of the recording apparatus 200 into the display mode of the image display apparatus 100. In this embodiment, the CPU 101 and the graphic processor 107 function as a display mode converting device. Icons “<<”, “decision”, “mode”, “zoom”, and “>>” of icons of the GUI screen of the recording apparatus 200 such as shown in FIG. 5 are representations corresponding to those of the remote controller of the image display apparatus 100. In this embodiment, the CPU 101 and the graphics processor 107 of the image display apparatus 100 replace the icons of the GUI screen of the recording apparatus 200 with “<<”, “blue”, “red”, “green”, and “>>” and display them so that the icons of the GUI screen of the recording apparatus 200 become representations corresponding to those of the remote controller of the image display apparatus 100. When a corresponding remote controller key of the image display apparatus 100 is pressed, the image display apparatus 100 transmits an ID corresponding to that of the GUI screen of the recording apparatus 200 to the recording apparatus 200.

According to this embodiment, the display mode of icons and so on of the GUI screen matches that of the remote controller of the image display apparatus 100 operated by the user, which allows easy operation of the GUI screen by the user.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A GUI (Graphical User Interface) display system which displays a GUI of a recording apparatus in a display apparatus, wherein
said display apparatus comprises:
a display device which displays a GUI related to data transmitted from said recording apparatus; and
a blending device which blends an updated image of an area updated and displayed in the GUI with the GUI being displayed by said display device, and
said display device displays the GUI with which the updated image is blended by said blending device.

2. The GUI display system according to claim 1, wherein
said display apparatus further comprises an updated image generating device which generates the updated image of the area updated and displayed in the GUI, and
said blending device blends the updated image generated by said updated image generating device with the GUI being displayed by said display device.

3. The GUI display system according to claim 1, wherein
said recording apparatus further comprises an updated image generating device which generates the updated image of the area updated and displayed in the GUI, and
said blending device of said display apparatus blends the updated image generated by said updated image generating device of said recording apparatus with the GUI being displayed by said display device.

4. The GUI display system according to claim 1, wherein
said recording apparatus further comprises an updated area data generating device which generates coordinate data of the area updated and displayed in the GUI, and
said blending device of said display apparatus blends the updated image in an area related to the coordinate data generated by said updated area data generating device of said recording apparatus with the GUI being displayed by said display device.

5. The GUI display system according to claim 1, wherein
said display apparatus further comprises a display mode converting device which converts the GUI related to the data transmitted from said recording apparatus into a display mode of said display apparatus.

6. A recording apparatus which allows a GUI (Graphical User Interface) of said recording apparatus to be displayed in a display apparatus, comprising
an updated area data generating device which generates coordinate data of an area updated and displayed in the GUI,
said recording apparatus transmitting the coordinate data generated by said updated area data generating device with data related to the GUI to said display apparatus.

7. The recording apparatus according to claim 6, further comprising
an updated image generating device which generates an updated image of the area updated and displayed in the GUI,
said recording apparatus transmitting data of the updated image generated by said updated image generating device with the data related to the GUI to said display apparatus.

8. A GUI display method of displaying a GUI (Graphical User Interface) of a recording apparatus in a display apparatus, comprising the steps of:
a display device of the display apparatus displaying a GUI related to data transmitted from the recording apparatus; and
a blending device of the display apparatus blending an updated image of an area updated and displayed in the GUI with the GUI being displayed by the display device, wherein
the display device of the display apparatus displays the GUI with which the updated image is blended by the blending device.
